(19) United States
(12) Patent Application Publication
(10) Pub. No.: US 2006/0206803 A1
(43) Pub. Date: Sep. 14, 2006

(54) INTERACTIVE DESKTOP WALLPAPER SYSTEM

(76) Inventor: Jeffrey Carl Smith, Burbank, CA (US)

Correspondence Address: Jeffrey Carl Smith, 1711 N. California St, Burbank, CA, 91505, US

(21) Appl. No.: 10/906,942

(22) Filed: Mar. 14, 2005

(51) Int. Cl. G06F 17/00; G06F 15/00

(52) U.S. Cl. 715/513

(57) ABSTRACT

A system fetches, parses, organizes and displays aggregated XML-based content, including—but not limited to—RSS feeds, XML feeds, ATOM feeds, RDF feeds, CDF feeds and Podcasts, embedding that information into a newsreader or aggregator format in the computer user's desktop wallpaper. This creates a fully interactive wallpaper system that pushes information the user desires to his desktop on a regular and continuing basis. In various embodiments, the newsreader can include a variety of content, including Internet search boxes, weather information, advertising and more. The newsreader includes “Hide” and “Show” buttons to allow the computer user to hide the interactive content from view. While the current embodiment is for the display of news information aggregated from Internet sources, the system can be used for many other applications, as well, including—but not limited to—intra—and interoffice communication, technical diagnostic display, document and media editing/management and instant messaging.

### BACKGROUND OF THE INVENTION

Access to information continues to offer individuals, companies and governmental agencies throughout the world more capabilities and options in communicating news, images, video, audio and other content. The Internet has become and continues to expand its position as the main source of communication between private, government and commercial networks.

This growth of communication has also increased the accessibility of information and news from a wide variety of sources. This news is increasingly delivered via XML-based feeds, often called RSS (Rich Site Summaries or Really Simple Syndication). RSS originated from Netscape in the early days of the World Wide Web. But the capability of RSS has been combined and expanded with the rise of extensible Markup Language (XML) to create the Internet version of a raw newswire.

RSS is a way of creating a broadcast version of a blog or news page. Any website, network or content management system that frequently updates content and is willing to let others republish it often creates an RSS file. Currently, over 8,000,000 newsfeeds are available, and that number is growing exponentially.

Typically called “syndication,” the RSS file is an XML-formatted file that can be used at other sites or by other intermediary software such as news aggregators. The original incarnation was to use RSS to include several headlines on a personalized portal page. But XML-based feeds such as RSS are increasingly being utilized in other end-user applications, such as aggregators.

Popular online aggregators, such as Blogdex, Daypop, Popdex, Technorati, Blogstreet and Feedster, are able to represent new content in a user-friendly format. Because Weblog entries and news stories link to each other, these aggregators can quickly find the most popular new items. For many readers, sites such as the DayPop, Bloglines and Newsgator are useful sources of news.

Though many readers use RSS by turning to an aggregator Website, many others use applications known as headline readers. A headline reader performs the same function as an aggregator, but is a stand-alone application that usually resides on the user's own computer. Desktop readers, such as AmphetaDesk, FeedDemon and NewsGator, divide the screen into three panes:

(1) a list of RSS feeds to which a reader subscribes

(2) a list of titles from the currently selected feed

(3) the text of the currently selected item

As Web browsers continue to evolve, support for XML-based data is being integrated into their capabilities. Firefox and Safari have begun to include some rudimentary support for parsing and reading RSS feeds in a browser-based environment.

Standalone aggregators share a common strength and a common weakness. With frequent updates, these sites help keep track of the latest news, opinions, and rumors. Unfortunately, the frequent updates create a bandwidth bottleneck on the user's network, as the updates constantly bring more information to the user. Plus, having an additional program open at all times is a drain on the computer's resources.

The main shortcoming that this method addresses is the need for an additional program to provide the aggregation service. Web-based aggregators require the user to first access the Internet with a browser and to then navigate to the aggregation site, sometimes requiring a login name and password to access the content. Desktop aggregators require the user to open a program to access the news content. Each of these solutions takes time and uses computer resources.

Additionally, no other solution provides the user with the experience of an always-on, always-ready experience.

Thus, it can be appreciated that there is a significant need for a system and method that summarizes the new content, presents it in a compact format, combines multiple sources in one interface, and provides links to the full content utilizing a server-side method, as opposed to a client-side method. Additionally, the embedding of the aggregator into the user's computer desktop wallpaper reduces the resource drain by utilizing the Operating System's current resources, creating an always-on, always accessible news delivery system.

Objects

It is therefore an object of the invention to fetch content from various websites and deliver it to the user's desktop wallpaper.

It is another object of the invention to update the content at regularly scheduled intervals.

It is another object of the invention to allow the user to interact with the content, such as by clicking a headline or entering information into a form.

It is another object of the invention to accept and store URLs of existing XML-based data, such as—but not limited to—RSS, RDF, CDF and ATOM feeds from websites and weblogs on a networked server.

It is another object of the invention to scrape headlines, images and related content from non-affiliated websites and weblogs that do not have the ability to provide XML-based data, reformatting this data as RSS.

It is another object of the invention to parse this XML-based data into standard HTML (HyperText Markup Language)

### SUMMARY OF THE INVENTION

In accordance with the present invention, there is provided a delivery and aggregation application designed to make accessing computer network-based XML content through the end users' desktop wallpaper. Desktop Wallpaper is generally used as decoration on a computer screen, allowing the user to express his or her individuality. This invention creates a new type of desktop wallpaper that pulls information from the user's favorite websites, embedding that content into the wallpaper itself, organizing the data, and updating that content throughout the day.

In one implementation, the wallpaper could feature headlines from various online news sources, such as CNN or Reuters. The headlines would update at regularly scheduled intervals, always presenting the user with the latest content. A click to one of the headlines would load the full story in the user's Internet browser.

The system includes a “Hide/Show” activation button to allow the end user the option of displaying or hiding the interactive content.

This invention offers the unique advantage to the user of organizing and presenting relevant information in a new way, relieving the user of the need to open additional programs or remember to visit certain Internet sites on a regular basis.

### DESCRIPTION OF THE PREFERRED EMBODIMENT

To install the invention, a user downloads the interactive wallpaper executable installer program 24 from our web server 10. (The user could also gain access to the invention via CD or DVD, or as a component inside a larger software program, such as a browser or operating system. We describe the invention in terms of downloading in this document simply because the initial distribution of the invention is via web server 10 download).

The user double-clicks the installer icon and the interactive wallpaper executable installer program 24 places graphics files 26, the interactive wallpaper HTML/XML interface 22 and the interactive wallpaper configuration files 28 into a folder on the user's computer hard drive.

The interactive wallpaper configuration files 28 change the user's computer settings to display the interactive wallpaper HTML/XML interface 22 as the computer's desktop wallpaper pattern, and configure the computer to accept dynamic, interactive content within the desktop wallpaper environment.

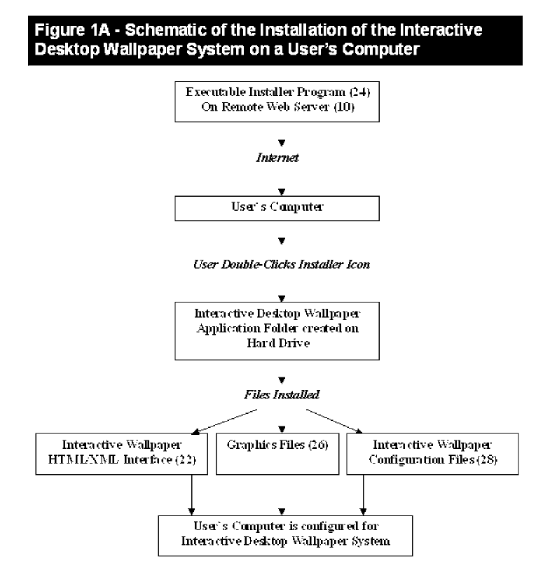

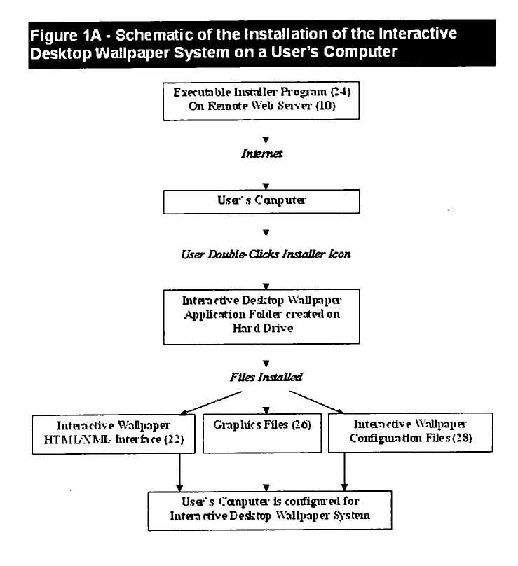

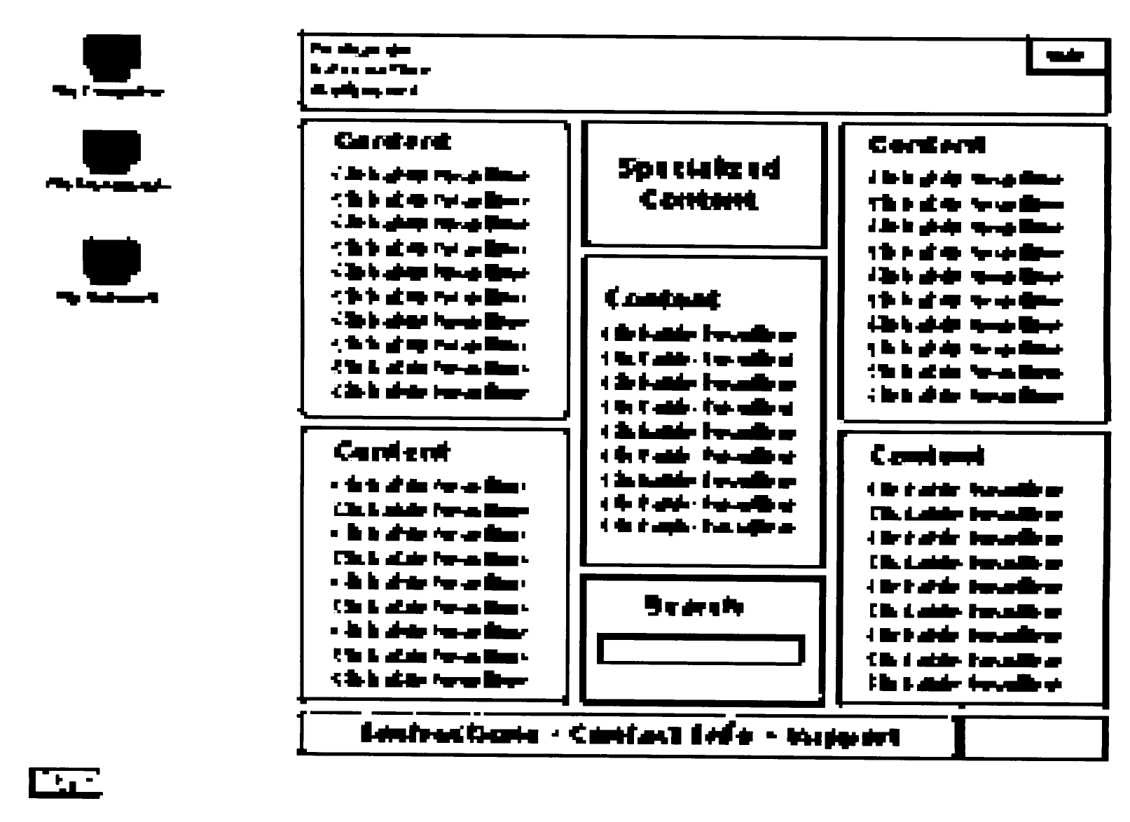

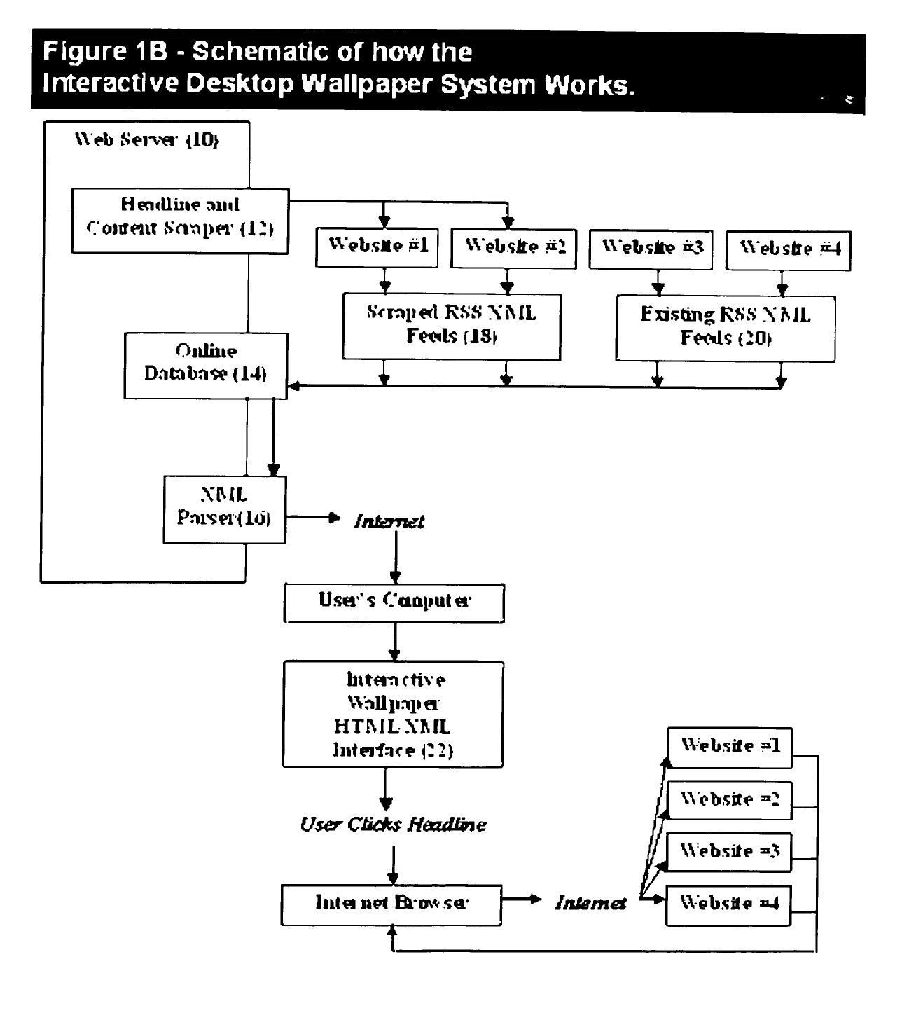

See FIG. 1A for a detailed schematic on this process.

The invention works by updating, storing and delivering content using the web server's online database 14 and the interactive wallpaper HTML/XML interface 22, residing on the user's computer desktop.

Existing XML-based feeds 20 are updated regularly to the online database 14. Content from websites that do not currently offer RSS feeds is fetched using the headline & content scraper 12. This content is converted to scraped RSS/XML feeds 18 and stored on the online database 14.

The scraped RSS/XML feeds 18 and the exising RSS/XML feeds are then converted to HTML using the XML parser 16.

This HTML data is then pushed via the Internet to the user's computer and is rendered to the interactive wallpaper HTML/XML interface 22.

The user can read the content and—if he's interested—click a headline or link, which will open the user's browser window containing the full story or content, served by the original website that was the source of the content.

See FIG. 1B for a detailed schematic on this process.

Operation

The user downloads the interactive wallpaper executable installer program 24 from the web server 10. (Alternately, the installer could be distributed via CD, DVD or incorporated into a larger program).

The user double-clicks the installer icon to install and configure his computer for use with the interactive desktop wallpaper system.

The user will then be able to see the latest headlines, sports scores, stock prices and other content on his desktop wallpaper.

The user can interact with this content by clicking a headline or completing a form. The interactive desktop wallpaper system will launch the user's browser program and deliver the full story or form results to him.

The interactive desktop wallpaper content is updated constantly throughout the day without the need for the user to do anything.

If the user needs his computer desktop space available to him, he can click the “HIDE” button on the interactive wallpaper HTML/XML interface 22, and all interactive content will be hidden. By clicking the “SHOW” button on the interactive wallpaper HTML/XML interface 22, the interactive content returns to view.

FIG. 2 shows an example computer desktop featuring the Deskpops Interactive Wallpaper System.

The content is embedded into the desktop wallpaper, and each headline can be clicked to open the entire story in the user's web browser.

Other specialized boxes offer space for specialized content such as search, weather, stock quotes, advertising, etc.

The “Hide” button will remove all interactive content from the desktop until the user clicks the “Show” button.

### ALTERNATIVE EMBODIMENTS

One alternative embodiment is that instead of providing news and informational content, the interactive wallpaper system could be used as a communication system within office or other environments. A backend program could allow users to post information that is pushed to the other users in the environment, such as notices of meetings or results of testing.

Another alternative embodiment is that the interactive wallpaper system could be used for tracking information in research or business. For example, an interactive desktop wallpaper system could be configured to track auctions on ebay for retailers, press releases and financial filings from competitors in a particular industry or the latest stories relating to search terms relevant to research developments.

Another alternative is the use of the interactive desktop wallpaper system for polling, voting and information gathering.

Another alternative is the use of the interactive desktop wallpaper system for advertising and marketing.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. An interactive desktop wallpaper system for aggregating and displaying syndicated news feeds and additional xml-based content. comprising: means for storing, executing and delivering the content to the desktop wallpaper system; means for storing headlines in a cached database for organization and retrieval, functionally connected to said means for storing, executing and delivering the content to the desktop wallpaper system; means for parsing the xml code into regular html code for viewing through the browser-based desktop wallpaper system; means for providing content on subjects of interest to the end user, functionally connected to said means for parsing the xml code into regular html code for viewing through the browser-based desktop wallpaper system, and functionally connected to said means for storing headlines in a cached database for organization and retrieval; means for displaying the content the user desires to see, functionally connected to said means for parsing the xml code into regular html code for viewing through the browser-based desktop wallpaper system; and means for configuring the end user's computer system to accept the incoming content and to allow the system to be fully interactive, functionally connected to said means for displaying the content the user desires to see.

2. The interactive desktop wallpaper system in accordance with claim 1, wherein said means for storing, executing and delivering the content to the desktop wallpaper system comprises a server.

3. The interactive desktop wallpaper system in accordance with claim 1, wherein said means for storing headlines in a cached database for organization and retrieval. comprises a database.

4. The interactive desktop wallpaper system in accordance with claim 1, wherein said means for parsing the xml code into regular html code for viewing through the browser-based desktop wallpaper system comprises a xml parser.

5. The interactive desktop wallpaper system in accordance with claim 1, wherein said means for providing content on subjects of interest to the end user. comprises an existing xml-based feeds.

6. The interactive desktop wallpaper system in accordance with claim 1, wherein said means for displaying the content the user desires to see. comprises an interactive wallpaper html/xml interface.

7. The interactive desktop wallpaper system in accordance with claim 1, wherein said means for configuring the end user's computer system to accept the incoming content and to allow the system to be fully interactive. comprises an interactive wallpaper configuration files.

8. An interactive desktop wallpaper system for aggregating and displaying syndicated news feeds and additional xml-based content. comprising: a server, for storing, executing and delivering the content to the desktop wallpaper system; a database, for storing headlines in a cached database for organization and retrieval, functionally connected to said Server; a xml parser, for parsing the xml code into regular html code for viewing through the browser-based desktop wallpaper system; an existing xml-based feeds, for providing content on subjects of interest to the end user, functionally connected to said XML parser, and functionally connected to said Database; an interactive wallpaper html/xml interface, for displaying the content the user desires to see, functionally connected to said XML parser; and an interactive wallpaper configuration files, for configuring the end user's computer system to accept the incoming content and to allow the system to be fully interactive, functionally connected to said Interactive Wallpaper HTML/XML Interface.

9. The interactive desktop wallpaper system as recited in claim 8, further comprising: a headline & content scraper, for scraping content from web sites that don't provide an xml feed, functionally connected to said Server, and functionally connected to said Database.

10. The interactive desktop wallpaper system as recited in claim 8, further comprising: an executable installer program, for installing the interactive desktop wallpaper system onto the user's computer system, functionally connected to said Server, functionally connected to said Interactive Wallpaper HTML/XML Interface, and functionally connected to said Interactive Wallpaper configuration files.

11. The interactive desktop wallpaper system as recited in claim 8, further comprising: a graphics files, for offering an attractive and pleasing desktop wallpaper for the end user, functionally connected to said Database, and functionally connected to said Interactive Wallpaper HTML/XML Interface.

12. The interactive desktop wallpaper system as recited in claim 9, further comprising: an executable installer program, for installing the interactive desktop wallpaper system onto the user's computer system, functionally connected to said Server, functionally connected to said Interactive Wallpaper HTML/XML Interface, and functionally connected to said Interactive Wallpaper configuration files.

13. The interactive desktop wallpaper system as recited in claim 9, further comprising: a graphics files, for offering an attractive and pleasing desktop wallpaper for the end user, functionally connected to said Database, and functionally connected to said Interactive Wallpaper HTML/XML Interface.

14. The interactive desktop wallpaper system as recited in claim 10, further comprising: a graphics files, for offering an attractive and pleasing desktop wallpaper for the end user, functionally connected to said Database, and functionally connected to said Interactive Wallpaper HTML/XML Interface.

15. The interactive desktop wallpaper system as recited in claim 12, further comprising: a graphics files, for offering an attractive and pleasing desktop wallpaper for the end user, functionally connected to said Database, and functionally connected to said Interactive Wallpaper HTML/XML Interface.

16. An interactive desktop wallpaper system for aggregating and displaying syndicated news feeds and additional xml-based content. comprising: a server, for storing, executing and delivering the content to the desktop wallpaper system; a headline & content scraper, for scraping content from web sites that don't provide an xml feed, functionally connected to said Server; a database, for storing headlines in a cached database for organization and retrieval, functionally connected to said Headline & Content Scraper, and functionally connected to said Server; a xml parser, for parsing the xml code into regular html code for viewing through the browser-based desktop wallpaper system; an existing xml-based feeds, for providing content on subjects of interest to the end user, functionally connected to said XML parser, and functionally connected to said Database; an interactive wallpaper html/xml interface, for displaying the content the user desires to see, functionally connected to said XML parser; an executable installer program, for installing the interactive desktop wallpaper system onto the user's computer system, functionally connected to said Interactive Wallpaper HTML/XML Interface, and functionally connected to said Server; a graphics files, for offering an attractive and pleasing desktop wallpaper for the end user, functionally connected to said Interactive Wallpaper HTML/XML Interface, and functionally connected to said Database; and an interactive wallpaper configuration files, for configuring the end user's computer system to accept the incoming content and to allow the system to be fully interactive, functionally connected to said Executable Installer Program, and functionally connected to said Interactive Wallpaper HTML/XML Interface.
